(19) United States
(12) Patent Application Publication
(10) Pub. No.: US 2009/0321430 A1
(43) Pub. Date: Dec. 31, 2009

(54) COOKING APPARATUS

(75) Inventor: Sang Jin JEONG, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD, Suwon-si (KR)

(21) Appl. No.: 12/416,373

(22) Filed: Apr. 1, 2009

(30) Foreign Application Priority Data
Jun. 25, 2008 (KR) 10-2008-60189

(51) Int. Cl. H05B 6/68

(52) U.S. Cl. 219/724

(57) ABSTRACT

An opening/closing structure of a door of a microwave oven is disclosed. The microwave oven includes a main body having a cooking chamber, a door link-coupled to the main body to open or close the cooking chamber, at least one link member including a cam portion hingedly coupled to the main body so as to be rotated when the door is opened or closed, and a link control device to press the cam portion to control rotation of the link member. Accordingly, the door can be securely opened or closed without rattling.

### CROSS-REFERENCE TO RELATED APPLICATION

This application claims the benefit of Korean Patent Application No. 2008-0060189, filed on Jun. 25, 2008 in the Korean Intellectual Property Office, the disclosure of which is incorporated herein by reference.

### BACKGROUND OF THE INVENTION

1. Field of the Invention

The present invention relates to a microwave oven, and more particularly, to a microwave oven equipped with a door which is opened or closed in an up/down direction by means of links.

2. Description of the Related Art

Generally, a microwave oven is an appliance for heating or cooking food using frictional heat caused by translational motion of water molecules contained in food by irradiating microwaves generated from a magnetron to food.

Recently, in order to efficiently utilize a kitchen space, in many cases, a microwave oven is used together with an oven range rather than used independently. In other words, a microwave oven with a hood function is installed above an oven range, so as to exhaust steam and smell generated from the oven range. Also, racks for storing kitchen utensils, such as dishes, are installed around the microwave oven. It is a general trend that a microwave oven and an oven range are not independently used but are installed together with racks to be used just like a built-in assembly. Such a structure is disclosed in Korean Utility Model Registration No. 20-0341914.

Because a conventional microwave oven has a door coupling structure such that a side portion of a door is hingedly coupled to a main body, when the door is in an opened state, the door may make interference with racks installed around the microwave oven. Further, because the installation position of the microwave oven is generally set to a user's height, preferably, a user's eye level, there is a risk that a user gets hurt when she/he cooks food using an oven range while the door of the microwave oven is opened. In order to solve such problems, it is desired to develop a microwave oven having a door coupling structure such that a door can be opened or closed in an up/down direction while being maintained in an erected state.

A microwave oven, in which a door can be opened or closed in an up/down direction while being maintained in an erected state by means of a link structure, is disclosed in European Patent No. EP 0 754 920 B1.

However, the microwave oven disclosed in European Patent No. EP 0 754 920 B1 has a problem such that a door cannot be securely opened or closed. In other words, because link members are separately mounted to both side portions of the door, the link members are operated independently from each other. Therefore, when a user opens or closes the door, the door rattles. This may cause a problem that microwaves leak or a problem that a microwave switch cuts off power supply and thus the operation of the microwave oven is abnormally terminated.

In order to prevent leakage of microwaves through a door equipped with a link structure, an additional device for excellent door sealing is necessary. Further, an additional device enabling a user to easily open the door is necessary.

### SUMMARY OF THE INVENTION

Therefore, it is an aspect of the invention to provide a microwave oven having a door coupling structure, by which rattling of a door is prevented and a door can be securely opened or closed.

It is another aspect of the invention to provide a microwave oven with an enhanced door sealing structure so as to prevent leakage of microwaves while a door is closed.

It is a further aspect of the invention to provide a microwave oven equipped with a device enabling a user to easily open a door.

It is a still further aspect of the invention to provide a microwave oven equipped with a braking device, by which a door can be stopped at a user's desired position while the door is opened or closed.

Additional aspects and/or advantages of the invention will be set forth in part in the description which follows and, in part, will be obvious from the description, or may be learned by practice of the invention.

In accordance with an aspect of the invention, there is provided a microwave oven comprising: a main body having a cooking chamber; a door link-coupled to the main body to open or close the cooking chamber; at least one link member provided so as to be rotated when the door is opened or closed; and a link control device to control operation of the link member, the link control device including a first pressing device. When the door is closed, the first pressing device rotates the link member in a first direction. When the door is opened, the first pressing device rotates the link member in a second direction opposite to the first direction.

The link member may include a cam portion in contact with the first pressing device.

The cam portion may include a first curved surface to rotate the link member in the first direction, and a second curved surface to rotate the link member in the second direction.

The first pressing device may include a pressing roller in contact with the cam portion, a first elastic member to closely contact the pressing roller to the cam portion, and a first guide part to guide the pressing roller to move according to change of a radius of the cam portion.

The first curved surface may include a first contact portion in contact with the pressing roller, and the first contact portion may be positioned above a line from a rotational center of the cam portion to a rotational center of the pressing roller.

The first curved surface may have a concave shape.

The second curved surface may include a second contact portion in contact with the pressing roller, and the second contact portion may be positioned below a line from a rotational center of the cam portion to a rotational center of the pressing roller.

The second curved surface may be formed such that a radius of curvature is gradually decreased.

The link control device may include a braking device to stop rotation of the link member when the door is opened at a predetermined angle (α) or more.

The link member may generate a frictional force with the braking device.

The link member may include a cam portion in friction with the braking device.

The cam portion may include a third curved surface pressed by the braking device.

The braking device may include a friction roller in contact with the third curved surface, a second elastic member to closely contact the friction roller to the third curved surface, and a second guide part to guide the friction roller to move according to change of a radius of the cam portion.

The link control device may include a second pressing device to rotate the link member in a direction of opening the door.

The second pressing device may include a connecting pin mounted at a position apart from a rotational center of the cam portion, and a second elastic member connected to the connecting pin to rotate the cam portion.

The second pressing device may include a connecting hole formed at a position apart from a rotational center of the cam portion, and a second elastic member connected to the connecting hole to rotate the cam portion.

The at least one link member may include a plurality of link members mounted to both side surfaces of the door, and the link control device may further include connecting members to connect the plurality of link members.

The connecting members may be mounted outside the cooking chamber.

Each of the connecting members may have a closed curve-shaped cross section.

Each of the connecting members may have a ring-shaped cross section.

The microwave oven may further comprise a fixing bracket mounted in the main body. The cam portion may be hingedly coupled to the fixing bracket, and the fixing bracket may closely cover both surfaces of the cam portion.

The fixing bracket may have a U-shaped cross section so that the cam portion is fitted thereinto.

The microwave oven may further comprise a noise reduction member provided between the fixing bracket and the cam portion. The noise reduction member may be made of a plastic material.

In accordance with another aspect of the invention, there is provided a microwave oven comprising: a main body having a cooking chamber; a door to open or close the cooking chamber; a link member to connect the main body and the door, the link member including a cam portion having different radii of curvature; and a link control device to press the cam portion to change a rotational direction of the link member. The rotational direction of the link member is changed according to transition from one of the radii of curvature of the cam portion to another radius of curvature of the cam portion.

In accordance with a further aspect of the invention, there is provided a microwave oven comprising: a main body having a cooking chamber; a door link-coupled to the main body to open or close the cooking chamber; a plurality of link members mounted to both side surfaces of the door; and a link control device including connecting members to connect the plurality of link members to control rotation of the link members.

### BRIEF DESCRIPTION OF THE DRAWINGS

These and/or other aspects and advantages of the exemplary embodiments of the invention will become apparent and more readily appreciated from the following description of the embodiments, taken in conjunction with the accompanying drawings, of which:

FIG. 1 is a perspective view showing an exterior appearance and an interior structure of a microwave oven according to the present invention;

FIG. 2 is an exploded perspective view showing a link coupling structure of a main body and a door of the microwave oven according to the present invention;

FIG. 3 is a side-sectional view showing an opened state of the door of the microwave oven according to the present invention;

FIG. 4 is a side-sectional view showing a closed state of the door of the microwave oven according to the present invention;

FIG. 5 is a sectional view showing a first pressing device in a closed state of the door;

FIG. 6 is an enlarged sectional view of an “A” portion of FIG. 5;

FIG. 7 is a sectional view showing the first pressing device in an opened state of the door;

FIG. 8 is an enlarged sectional view of a “B” portion of FIG. 7;

FIG. 9 is an exploded perspective view showing a second pressing device and a braking device of the door of the microwave oven according to the present invention;

FIG. 10 is a sectional view showing the braking device in an opened state of the door;

FIG. 11 is an enlarged sectional view of a “C” portion of FIG. 10;

FIG. 12 is a sectional view showing a second embodiment of the second pressing device to rotate a cam portion;

FIG. 13 is a sectional view showing a third embodiment of the second pressing device to rotate the cam portion; and

FIG. 14 is a sectional view showing a fourth embodiment of the second pressing device to rotate the cam portion.

### DETAILED DESCRIPTION OF THE PREFERRED EMBODIMENTS

Reference will now be made in detail to exemplary embodiments of the present invention, examples of which are illustrated in the accompanying drawings, wherein like reference numerals refer to like elements throughout. The embodiments are described below to explain the present invention by referring to the figures.

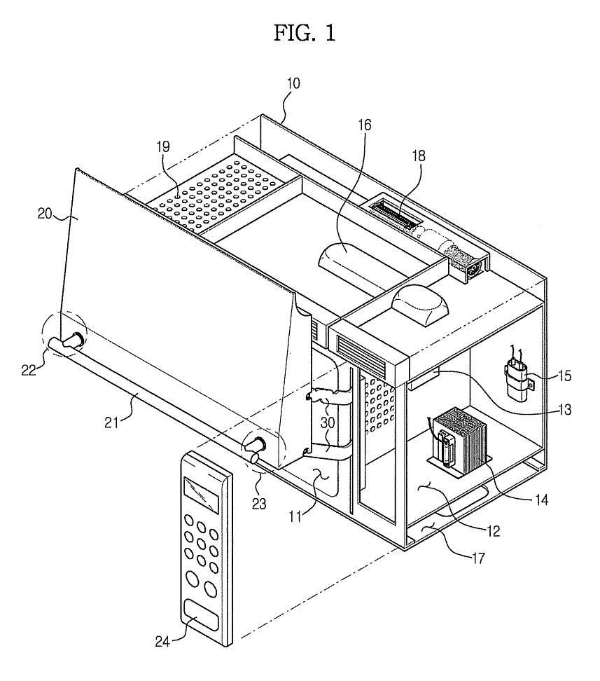

FIG. 1 is a perspective view showing an exterior appearance and an internal structure of a microwave oven according to the present invention.

As shown in FIG. 1, a microwave oven according to the present invention is installed above a cooking apparatus such as an oven range (not shown), and comprises a main body 10, whose rear plate is fixed to a wall. A microwave oven does not only function as a cooking appliance, but also has a function of sucking steam and smell from the cooking apparatus (not shown) installed therebelow and of exhausting them out of a room.

An inner space of the main body 10 is divided into a cooking chamber 11, in which food is received to be cooked, and an electrical component chamber 12, in which a variety of electrical components are mounted. The cooking chamber 11 has a front opening portion, through which food can be put thereinto or taken out thereof. A door 20 is mounted to the main body 10 to open or close the cooking chamber 11. The electrical component chamber 12 contains a variety of electrical components, including a magnetron 13 to supply high frequency waves, a high voltage transformer 14 to supply high voltage to the magnetron 13 and a high voltage condenser 15. The high frequency waves generated from the magnetron 13 are moved into the cooking chamber 11 through a guide duct 16 mounted to the top surface of the cooking chamber 11.

In order to exhaust air polluted by steam and smoke generated from a cooking apparatus (not shown), such as an oven range, installed below the microwave oven, an exhaust channel 17 and a blowing fan 18 are mounted to the main body 10. The exhaust channel 17 extends from a bottom of the main body 10 to a top of the main body 10, and the blowing fan 18 is mounted to an upper rear portion of the main body 10. Communicating holes 19 are also provided at the top of the main body 10, in order to exhaust smoke and smell generated from the cooking chamber 11.

A control panel 24, by which a user can control the components, is mounted to a front right portion of the main body 10.

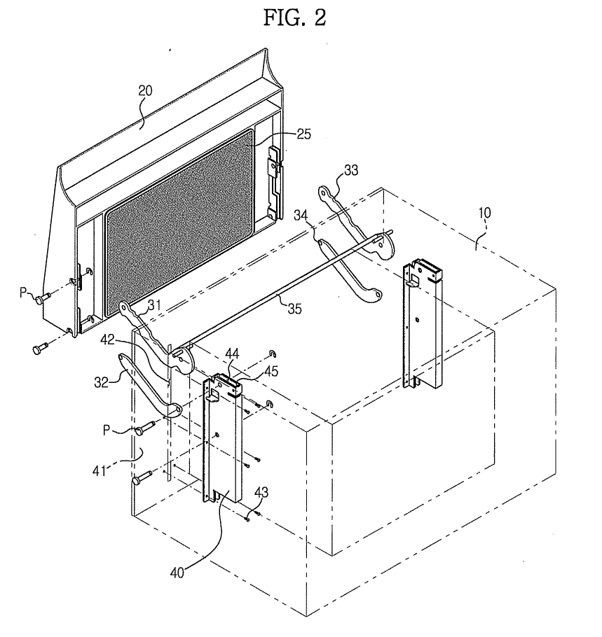

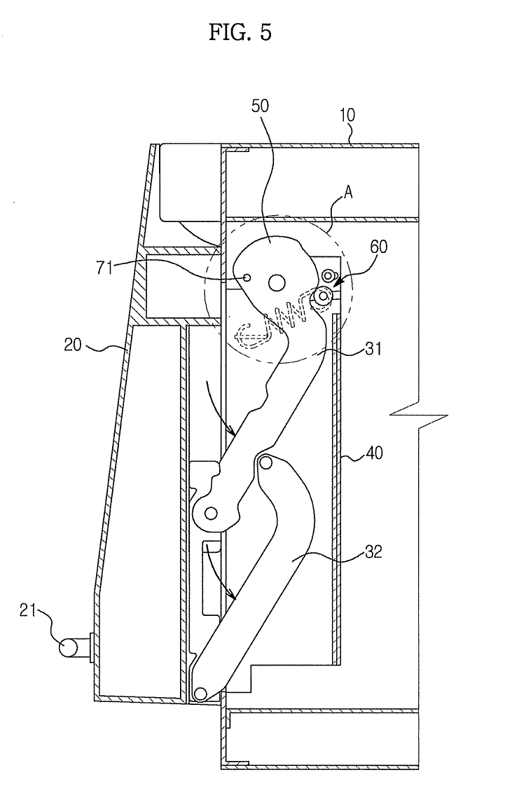

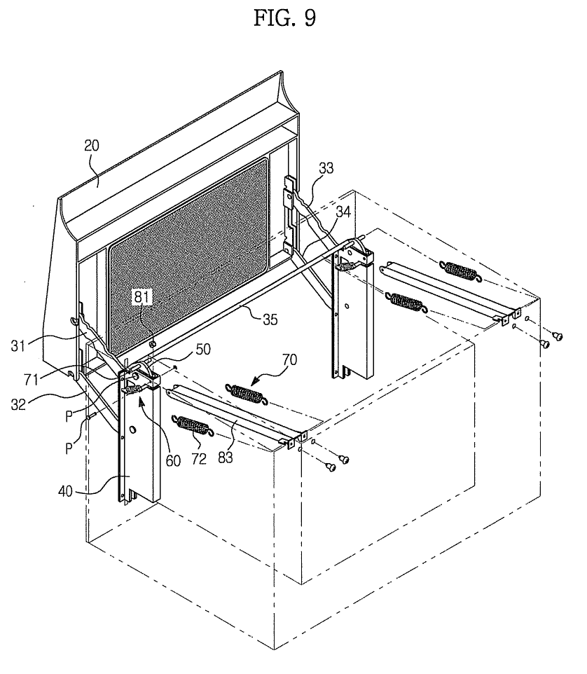

The microwave oven according to the present invention further comprises link members 30 which are mounted to both side surfaces of the door 20 and the main body 10 to connect the door 20 and the main body 10. When the door 20 is opened or closed in an up/down direction, the link members 30 are pivoted. The link members 30 are provided with a link control device to give various functions to the door 20. The link control device includes a connecting member 35 (refer to FIG. 2) to prevent rattling of the door 20, a first pressing device 60 (refer to FIGS. 5 to 8) to enhance door sealing between the door 20 and the main body 10 and to enable a user to easily open the door 20, a second pressing device 70 (refer to FIGS. 9 to 14) to assist a user to more easily open the door 20, and a braking device 80 (refer to FIGS. 9 to 11) to stop the door 20 at a desired position when the door 20 is opened at a predetermined angle or more. Hereinafter, the constitution of the link control device will be explained in detail.

FIG. 2 is an exploded perspective view showing a link coupling structure of the main body and the door of the microwave oven.

As shown in FIG. 2, the door 20 and the main body 10 are connected to each other by the link members. First to fourth link members 31, 32, 33 and 34 are pivotably coupled to the door 20 and the main body 10. A front panel 41 of the main body 10 is formed with slots 42 extending in an up/down direction, through which the first to fourth link members 31, 32, 33 and 34 pass. Because all of the first to fourth link members 31, 32, 33 and 34 are coupled to the main body 10 and the door 20 in the same manner, only the first link member 31 will be explained below.

A fixing bracket 40 is fixed to a rear surface of the front panel 41 of the main body 10 by means of screws 43. A right end portion of the first link member 31 is coupled to the fixing bracket 40. Because the fixing bracket 40 has a U-shaped cross section, the first link member 31 is fitted into a U-shaped valley portion 44 of the fixing bracket 40. The first link member 31 and the fixing bracket 40 are connected to each other by a pin (P) inserted therethrough, so that the first link member 31 is pivotably coupled to the fixing bracket 40. Because the fixing bracket 40 and the first link member 31 are made of a metal material, frictional noise due to contact therebetween may occur. In order to minimize frictional noise, which may occur when the first link member 31 pivots, a noise reduction member 45 of a plastic material is inserted into the U-shaped valley portion 44.

A left end portion of the first link member 31 is coupled to a rear surface of the door 20. The first link member 31 and the door 20 are connected to each other by a pin (P) inserted therethrough, so that the first link member 31 is pivotably coupled to the door 20.

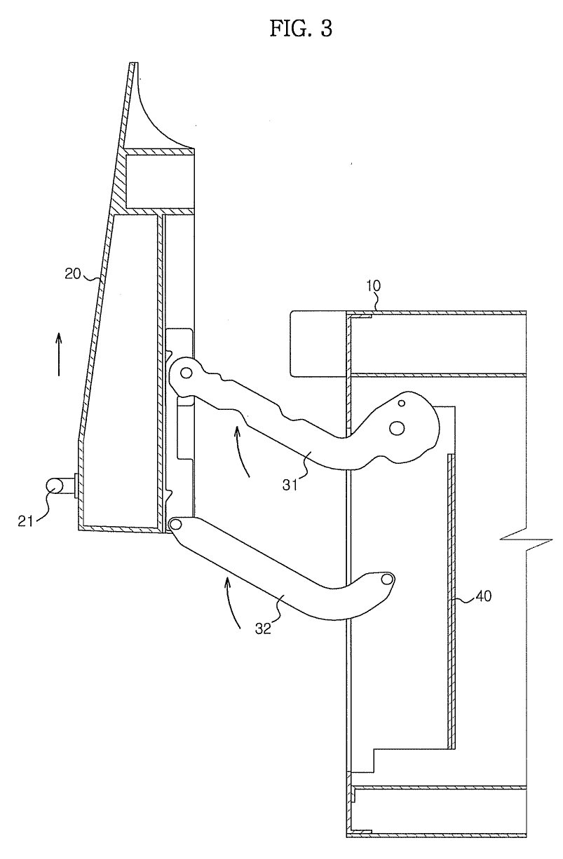

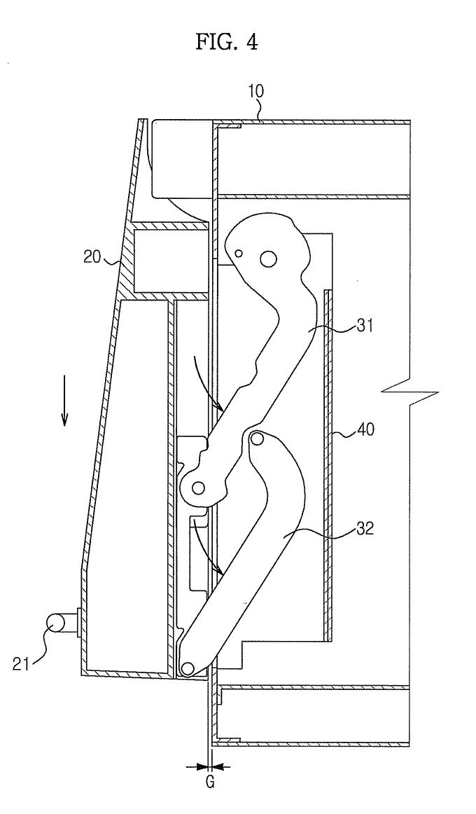

FIG. 3 is a side-sectional view showing an opened state of the door, and FIG. 4 is a side-sectional view showing a closed state of the door.

As shown in FIGS. 3 and 4, when the door 20 is moved up to open the cooking chamber 11, the first and second link members 31 and 32 are also pivoted up. When the door 20 is moved down to close the cooking chamber 11, the first and second link members 31 and 32 are also pivoted down. Although not illustrated in FIGS. 3 and 4, the third and fourth link members 33 and 34 (refer to FIG. 2) are also pivoted up or down.

However, referring to FIG. 2, because the first link member 31 and the third link member 33 are spaced apart from each other by a distance corresponding to a horizontal length of the door 20, if a user opens or closes the door 20 while imbalancedly grasping the door 20, the door 20 may rattle. For instance, as shown in FIG. 1, if a user pulls a right end portion 23 of a door knob 21, the right end portion 23 of the door 20 is first opened, and subsequently a left end portion 22 of the door 20 is opened. In order to prevent rattling of the door 20 due to an operational delay, the right end portion 23 and the left end portion 22 of the door 20 should be simultaneously opened even though a user pulls the right end portion 23 of the door knob 21. According to the present invention, as shown in FIG. 2, the connecting member 35 is provided to directly connect the first link member 31 and the third link member 33. Because the first link member 31 and the third link member 33 are simultaneously pivoted even though a user pulls the right end portion 23 of the door knob 21, the right end portion 23 and the left end portion 22 of the door 20 are also simultaneously opened. In other words, the right end portion 23 and the left end portion 22 of the door 20 can be simultaneously contacted to or separated from the main body 10. In order to minimize torsion of the connecting member 35, it is preferred that the connecting member 35 has a closed curve-shaped cross section. For example, the connecting member 35 is configured as a bar having a ring-shaped cross section.

It is preferable that the connecting member 35 is mounted outside the cooking chamber 11. This is because if the connecting member 35 connects the first link member 31 and the third link member 33 across the inner space of the cooking chamber 11, there is a risk that high frequency waves leak outside the cooking chamber 11.

Because the fixing bracket 40 is formed to have a U-shaped cross-section, when the first to fourth link members 31, 32, 33 and 34 are pivoted, the fixing bracket 40 closely covers both surfaces of each of the first to fourth link members 31, 32, 33 and 34. Accordingly, the fixing bracket 40 guides the pivoting motion of the first to fourth link members 31, 32, 33 and 34, thereby minimizing rattling of the first to fourth link members 31, 32, 33 and 34 and also minimizing rattling of the door 20.

As shown in FIG. 4, when the door 20 is in close contact with the main body 10, the cooking chamber 11 is in a closed state. If a contacting force of the door 20 to the main body 10 is so small that a narrow gap (G) is formed between the door 20 and the main body 10, there is a risk that high frequency waves leak out through the gap (G). In order to prevent such a problem, an additional device is needed to enhance door sealing between the door 20 and the main body 10 by closely contacting the door 20 to the main body 10 with a strong force.

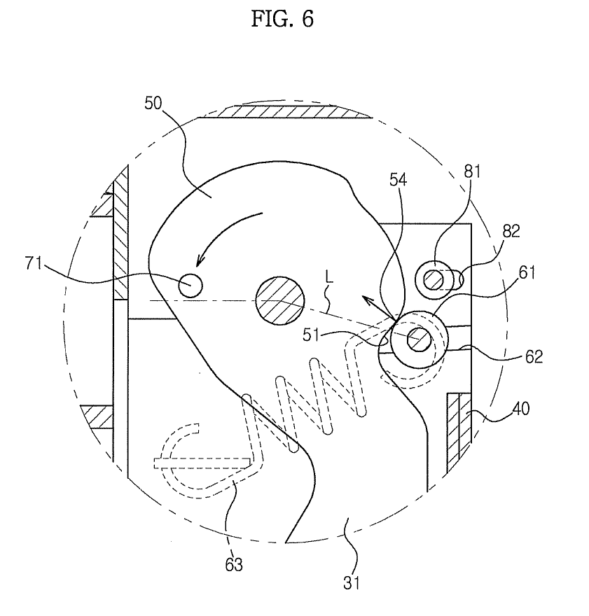

FIG. 5 is a sectional view showing the first pressing device in a closed state of the door, and FIG. 6 is an enlarged sectional view of an “A” portion of FIG. 5.

As shown in FIGS. 5 and 6, the first link member 31 includes a cam portion 50 which is pivotably coupled to the fixing bracket 40. The first pressing device 60 presses the cam portion 50, so as to pivot the first link member 31 in a direction of closely contacting the door 20 to the main body 10.

The cam portion 50 includes a first curved surface 51 having a concave shape. The first pressing device 60 includes a pressing roller 61 which is in contact with the first curved surface 51, and a first guide part 62 which is formed at the fixing bracket 40 to permit the pressing roller 61 to reciprocatingly move in a horizontal direction. The first pressing device 60 further includes a first elastic member 63 to closely contact the pressing roller 61 to the first curved surface 51 with a strong force. In this embodiment, the first elastic member 63 is configured as a tensile spring. A right end of the first elastic member 63 is connected to the pressing roller 61, and a left end of the first elastic member 63 is connected to the fixing bracket 40 (refer to FIG. 9).

An operational principle of the first pressing device 60 rotating the first link member 31 when the door 20 is in close contact with the main body 10 will be described with reference to FIGS. 5 and 6. Because the pressing roller 61 always receives a force from the first elastic member 63 to move the pressing roller 61 to the left, when the door 20 is closed, the pressing roller 61 is fitted into the first curved surface 51. At this time, a first contact portion 54 between the pressing roller 61 and the first curved surface 51 always lies above an imaginary line (L) from an axial center of the cam portion 50 to an axial center of the pressing roller 61. Therefore, the pressing roller 61 continuously presses the first contact portion 54 of the first curved surface 51 by the first elastic member 63, and the cam portion 50 and the first link member 31 are rotated in a counterclockwise direction. Because the first link member 31 is rotated in a direction of closely contacting the door 20 to the main body 10, door sealing between the door 20 and the main body 10 can be enhanced. Accordingly, leakage of high frequency waves from the cooking chamber 11 can be perfectly prevented.

A center portion of the door 20 is made of a transparent material so that a user can observe the inside of the cooking chamber 11. In order to prevent irradiation of high frequency waves outside the cooking chamber, a shielding plate 25 is mounted to the rear surface of the door 20.

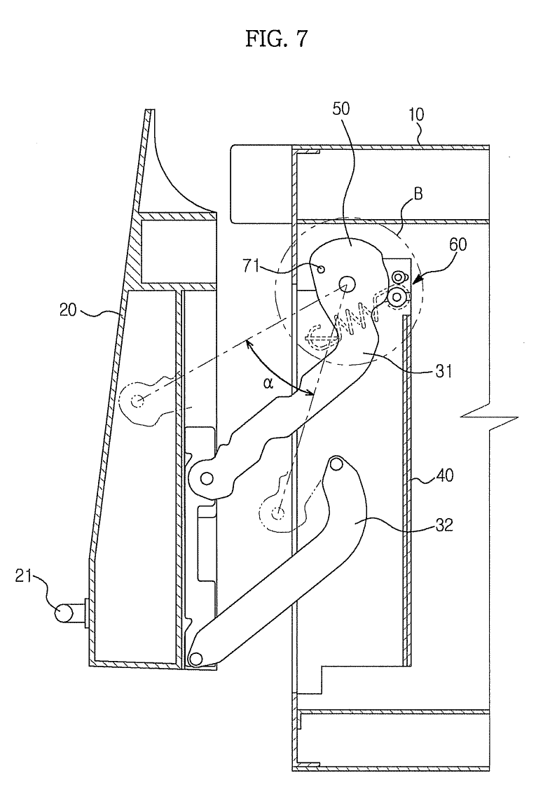

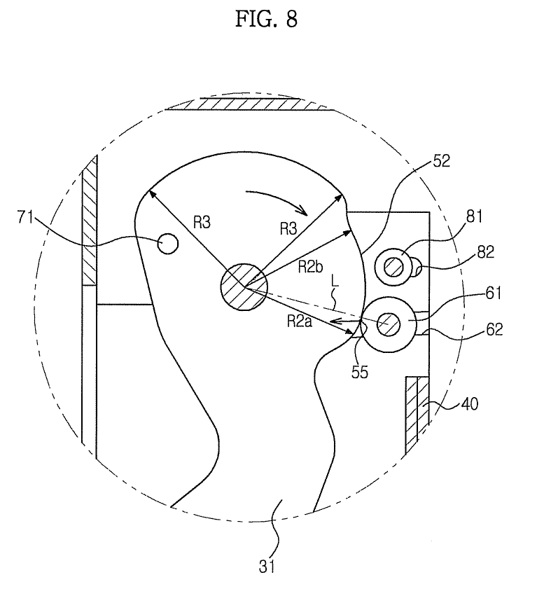

FIG. 7 is a sectional view showing the first pressing device in an opened state of the door, and FIG. 8 is an enlarged sectional view of a “B” portion of FIG. 7.

As shown in FIGS. 7 and 8, when the door 20 is opened, the pressing roller 61 comes into contact with a second curved surface 52 of the camp portion 50. The second curved surface 52 is formed such that a radius of curvature is gradually decreased in a counterclockwise direction. Because the radius of curvature of the second curved surface 52 is gradually decreased from a first value (R2a) to a second value (R2b) as the door 20 is opened, a second contact portion 55 between the pressing roller 61 and the second curved surface 52 lies below the imaginary line (L) from the axial center of the cam portion 50 to the axial center of the pressing roller 61. Therefore, the pressing roller 61 presses the second curved surface 52 when the door 20 is opened, and thus the cam portion 50 and the first link member 31 are rotated in a clockwise direction. Because the first pressing device 60 rotates the first link member 31 in a clockwise direction when the door 20 is opened, the door 20 can be easily opened.

FIG. 9 is an exploded perspective view showing the second pressing device and the braking device of the door.

As shown in FIG. 9, the first and third link members 31 and 33 are pivoted up by the second pressing device 70. Because the operational principles of the first and third link members 31 and 33 are the same as each other, only the first link member 31 will be explained below.

The cam portion 50 of the first link member 31 can be rotated on a pin (P) fixed to the fixing bracket 40. The second pressing device 70 is mounted to the cam portion 50, at a position above the pin (P), so as to rotate the cam portion 50 in a clockwise direction. The second pressing device 70 includes a connecting pin 71 mounted to an upper portion of the cam portion 50, and a second elastic member 72 connected to the connecting pin 71. The second elastic member 72 pulls the connecting pin 71 to rotate the cam portion 50 in a clockwise direction. As such, the second pressing device 70 rotates the first link member 31 up, and as a result the door 20 can be easily opened.

Referring again to FIGS. 5 and 6, as described above, when the door 20 is in a closed state, the first pressing device 60 rotates the cam portion 50 in a counterclockwise direction, so as to improve door sealing between the door 20 and the main body 10. However, the second pressing device 70 shown in FIG. 9 rotates the cam portion 50 in a clockwise direction when the door 20 is in a closed state, so that the door 20 can be easily opened. In other words, when the door 20 is in a closed state, the first pressing device 60 and the second pressing device 70 apply rotating forces to the cam portion 50 in an opposite direction to each other, and thus the rotating forces of the first and second pressing devices 60 and 70 are offset. In this regard, when the door 20 is in a closed state as shown in FIGS. 5 and 6, the connecting pin 71 is set to lie a little higher than a horizontal line of the pin (P), to thereby minimize a moment of rotating the cam portion 50 by the second pressing device 70.

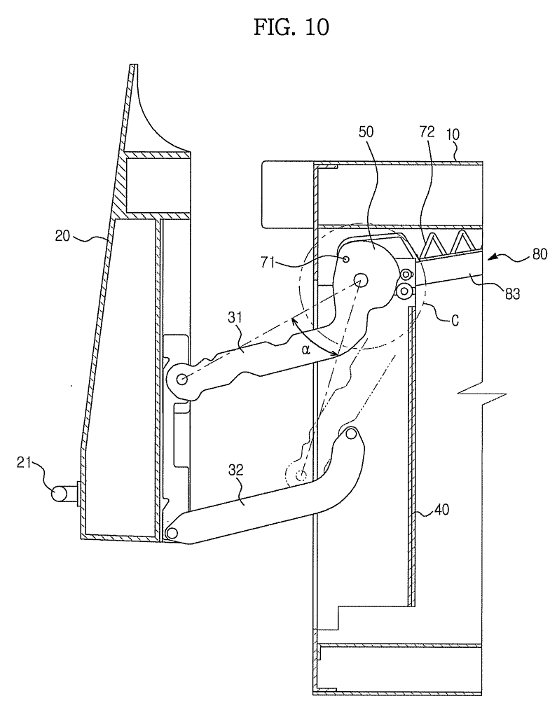

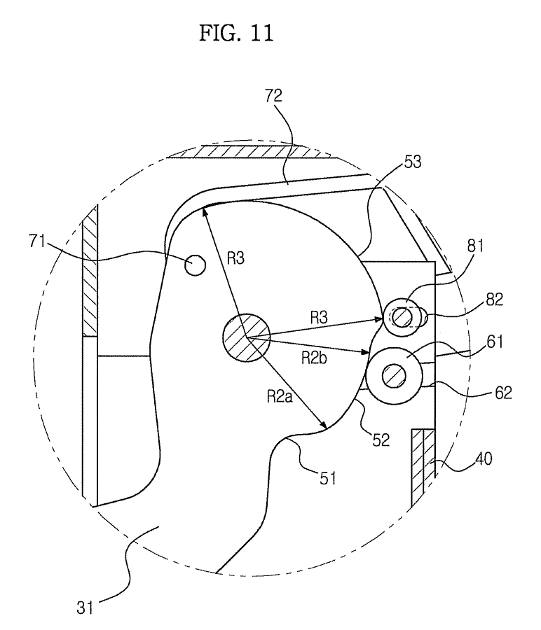

FIG. 10 is a sectional view showing the braking device in an opened state of the door, and FIG. 11 is an enlarged sectional view of a “C” portion of FIG. 10.

As shown in FIGS. 10 and 11, when the first link member 31 is rotated in a clockwise direction, the pressing roller 61 is in rolling friction with the second curved surface 52. When the first link member 31 is further rotated in a clockwise direction at a predetermined angle (α) or more, the cam portion 50 is stopped by the braking device 80. The braking device 80 includes a friction roller 81, a second guide part 82, an auxiliary bracket 83 and a second elastic member 72. Only when the first link member 31 is rotated at a predetermined angle (α) or more, the friction roller 81 is closely contacted to the cam portion 50.

Referring to FIGS. 5 to 8, when the door 20 is in a closed state or when the door 20 is in an opened state at an angle smaller than the predetermined angle (α), because the friction roller 81 is not in contact with the cam portion 50, the friction roller 81 does not generate a frictional force. This is because though the friction roller 81 receives a force from the auxiliary bracket 83 and the second elastic member 72 to move the friction roller 81 to the left, the movement of the friction roller 81 toward the cam portion 50 is restricted by the second guide part 82.

Referring to FIGS. 10 and 11, because the cam portion 50 is formed such that a radius of curvature R3 of a third curved surface 53 is larger than the radius of curvature R2a or R2b of the second curved surface 52, when the first link member 31 is rotated at the predetermined angle (α) or more, the cam portion 50 is closely contacted to the friction roller 81, and moves the friction roller 81 to the right.

A frictional force generated between the friction roller 81 and the third curved surface 53 makes balance with a force of rotating the cam portion 50 in a counterclockwise direction by a load of the door 20 and a force of rotating the cam portion 50 in a clockwise direction by the second elastic member 72 connected to the connecting pin 71. Therefore, if a user does not apply an additional force to the door 20, the first link member 31 is not rotated any more, and thus the door 20 is in a stopped state.

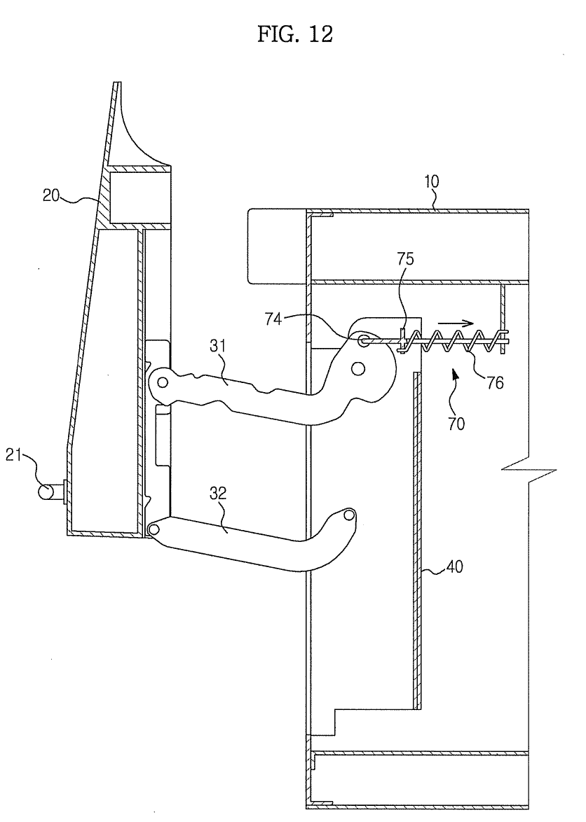

FIG. 12 is a sectional view showing a second embodiment of the second pressing device to rotate the cam portion.

Similar to the second pressing device 70 shown in FIG. 9, a second pressing device 70 shown in FIG. 12 is mounted to the cam portion 50. The second pressing device 70 of this embodiment is positioned above the pin (P) to rotate the cam portion 50 in a clockwise direction.

While the second pressing device 70 shown in FIG. 9 is constituted such that the second elastic member 72 is connected to the connecting pin 71 provided at the cam portion 50, the second pressing device 70 shown in FIG. 12 is constituted such that a connecting hole 74 is formed at the cam portion 50, an auxiliary connecting member 75 is connected to the connecting hole 74, and a second elastic member 76 pulls the auxiliary connecting member 75.

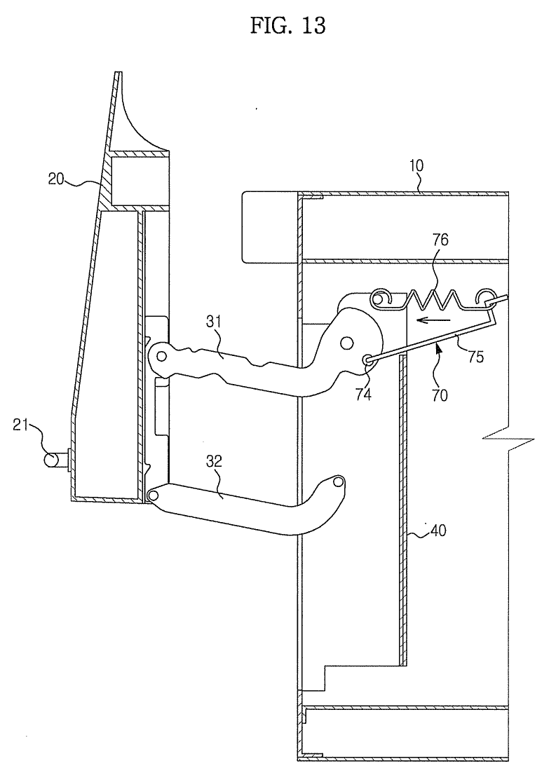

FIG. 13 is a sectional view showing a third embodiment of the second pressing device to rotate the cam portion.

A second pressing device 70 shown in FIG. 13 is mounted to the cam portion 50, at a position below the pin (P), to rotate the cam portion 50 in a clockwise direction. Describing in detail, a connecting hole 74 is formed at the cam portion 50, and an auxiliary connecting member 75 is connected to the connecting hole 74. A second elastic member 76 is connected to the fixing bracket 40 so as to move the auxiliary connecting member 75 to the left. When the auxiliary connecting member 75 is moved to the left by the second elastic member 76, the auxiliary connecting member 75 pushes the cam portion 50 down so that the cam portion 50 is rotated in a clockwise direction.

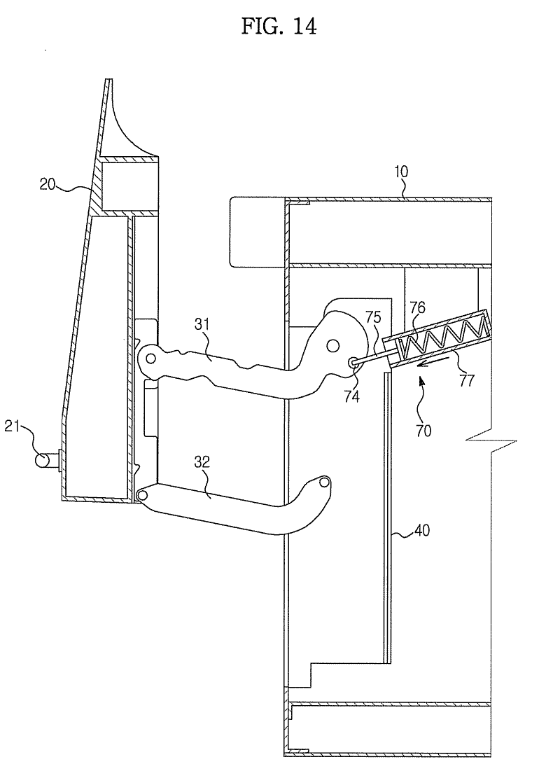

FIG. 14 is a sectional view showing a fourth embodiment of the second pressing device to rotate the cam portion.

Similar to the second pressing device 70 shown in FIG. 13, a second pressing device 70 shown in FIG. 14 is mounted to the cam portion 50, at a position below the pin (P). Also similar to the second pressing device 70 shown in FIG. 13, the second pressing device 70 shown in FIG. 14 is constituted such that a connecting hole 74 is formed at the cam portion 50, and an auxiliary connecting member 75 is connected to the connecting hole 74. However, different from the second pressing device 70 shown in FIG. 13, in which the second elastic member 76 is connected to the fixing bracket 40, the second pressing device 70 shown in FIG. 14 is constituted such that a second elastic member 76 is provided to be inserted into a cylinder 77. As shown in FIG. 14, when the second elastic member 76 moves the auxiliary connecting member 75 to the left, the auxiliary connecting member 75 pushes the cam portion 50. Such operation of the second pressing device 70 shown in FIG. 14 is the same as that of the second pressing device 70 shown in FIG. 13.

Hereinafter, the opening/closing operation of the door 20 of the microwave oven according to the present invention will be explained briefly.

Referring to FIGS. 3 and 4, the door 20 moves in an up/down direction while being maintained in an erected state, to open or close the cooking chamber 11. The door 20 is securely opened or closed without rattling severely, by the connecting member 35 connecting the first link member 31 and the third link member 33, by which the door 20 is link coupled to the main body 10.

Referring to FIGS. 5 and 6, in order to improve door sealing between the door 20 and the main body 10 in a closed state of the door 20, the first pressing device 60 presses the first curved surface 51 to rotate the first link member 31 in a counter-clockwise direction.

When a user opens the door 20 by a predetermined gap, as shown in FIGS. 7 and 8, the first pressing device 60 presses the second curved surface 52 to rotate the first link member 31 in a clockwise direction.

Referring to FIGS. 5 to 8, the first pressing device 60 serves to improve door sealing between the door 20 and the main body 10, and also serves to enable a user to easily open the door 20.

Referring to FIG. 9, the second pressing device 70 serves to enable a user to easily open the door 20 by rotating the first link member 31 in an clockwise direction. Accordingly, a user can open the door 20 with a small force from a closed state of the door 20 as shown in FIGS. 5 and 6.

Referring to FIGS. 10 and 11, when the door 20 is opened at the predetermined angle (α), the braking device 80 is operated. Accordingly, a user can position the door 20 at a desired position in the manipulation of opening or closing the door 20.

As apparent from the above description, because the door is opened or closed in an up/down direction while being maintained in an erected state, the microwave oven according to the present invention can improve space utilization by minimizing a radius of operation of the door.

Further, by virtue of the connecting member connecting the link members, the door can be securely opened or closed without severe rattling.

Further, by virtue of the first pressing device, door sealing between the door and the main body in a closed state of the door is improved, and the door can be easily opened.

Further, by virtue of the second pressing device, a user can easily open the door with a small force.

Further, by virtue of the braking device, a user can position the door at a desired position.

Although embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A cooking apparatus comprising:
a main body having a cooking chamber;
a door link-coupled to the main body to open or close the cooking chamber;
at least one link member provided so as to be rotated when the door is opened or closed; and
a link control device to control operation of the link member, the link control device including a first pressing device,
wherein when the door is closed, the first pressing device rotates the link member in a first direction, and
when the door is opened, the first pressing device rotates the link member in a second direction opposite to the first direction.

2. The cooking apparatus according to claim 1, wherein the link member includes a cam portion in contact with the first pressing device.

3. The cooking apparatus according to claim 2, wherein the cam portion includes a first curved surface to rotate the link member in the first direction, and a second curved surface to rotate the link member in the second direction.

4. The cooking apparatus according to claim 3, wherein the first pressing device includes a pressing roller in contact with the cam portion, a first elastic member to closely contact the pressing roller to the cam portion, and a first guide part to guide the pressing roller to move according to change of a radius of the cam portion.

5. The cooking apparatus according to claim 4, wherein the first curved surface includes a first contact portion in contact with the pressing roller,
and wherein the first contact portion is positioned above a line from a rotational center of the cam portion to a rotational center of the pressing roller.

6. The cooking apparatus according to claim 5, wherein the first curved surface has a concave shape.

7. The cooking apparatus according to claim 4, wherein the second curved surface includes a second contact portion in contact with the pressing roller,
and wherein the second contact portion is positioned below a line from a rotational center of the cam portion to a rotational center of the pressing roller.

8. The cooking apparatus according to claim 7, wherein the second curved surface is formed such that a radius of curvature is gradually decreased.

9. The cooking apparatus according to claim 1, wherein the link control device includes a braking device to stop rotation of the link member when the door is opened at a predetermined angle (α) or more.

10. The cooking apparatus according to claim 9, wherein the link member generates a frictional force with the braking device.

11. The cooking apparatus according to claim 10, wherein the link member includes a cam portion in friction with the braking device.

12. The cooking apparatus according to claim 11, wherein the cam portion includes a third curved surface pressed by the braking device.

13. The cooking apparatus according to claim 12, wherein the braking device includes a friction roller in contact with the third curved surface, a second elastic member to closely contact the friction roller to the third curved surface, and a second guide part to guide the friction roller to move according to change of a radius of the cam portion.

14. The cooking apparatus according to claim 1, wherein the link control device includes a second pressing device to rotate the link member in a direction of opening the door.

15. The cooking apparatus according to claim 14, wherein the second pressing device includes a connecting pin mounted at a position apart from a rotational center of the cam portion, and a second elastic member connected to the connecting pin to rotate the cam portion.

16. The cooking apparatus according to claim 14, wherein the second pressing device includes a connecting hole formed at a position apart from a rotational center of the cam portion, and a second elastic member connected to the connecting hole to rotate the cam portion.

17. The cooking apparatus according to claim 1, wherein the at least one link member includes a plurality of link members mounted to both side surfaces of the door,
and wherein the link control device further includes connecting members to connect the plurality of link members.

18. The cooking apparatus according to claim 17, wherein the connecting members are mounted outside the cooking chamber.

19. The cooking apparatus according to claim 18, wherein each of the connecting members has a closed curve-shaped cross section.

20. The cooking apparatus according to claim 18, wherein each of the connecting members has a ring-shaped cross section.

21. The cooking apparatus according to claim 2, further comprising:
a fixing bracket mounted in the main body,
wherein the cam portion is hingedly coupled to the fixing bracket, and
the fixing bracket closely covers both surfaces of the cam portion.

22. The cooking apparatus according to claim 21, wherein the fixing bracket has a U-shaped cross section so that the cam portion is fitted thereinto.

23. The cooking apparatus according to claim 22, further comprising:
a noise reduction member provided between the fixing bracket and the cam portion, the noise reduction member being made of a plastic material.

24. A cooking apparatus comprising:
a main body having a cooking chamber;
a door to open or close the cooking chamber;
a link member to connect the main body and the door, the link member including a cam portion having different radii of curvature; and
a link control device to press the cam portion to change a rotational direction of the link member,
wherein the rotational direction of the link member is changed according to transition from one of the radii of curvature of the cam portion to another radius of curvature of the cam portion.

25. A cooking apparatus comprising:
a main body having a cooking chamber;
a door link-coupled to the main body to open or close the cooking chamber;
a plurality of link members mounted to both side surfaces of the door; and
a link control device including a connecting member to connect the plurality of link members.

26. The cooking apparatus according to claim 25, wherein the link control device further comprising:
a first pressing device which urges the link member in a first rotational direction.

27. The cooking apparatus according to claim 26, wherein the first pressing device urges the link member in a first rotational direction when the door is in a closed position.

28. The cooking apparatus according to claim 27, wherein the first pressing device urges the link member in a second rotational direction while the door is opened.

29. The cooking apparatus according to claim 26, wherein the first pressing device is a pressing roller.

30. The cooking apparatus according to claim 29, wherein the pressing roller is urged to move towards the link member by a first elastic device.

31. The cooking apparatus according to claim 25, wherein the cooking apparatus is a microwave oven.

32. The cooking apparatus according to claim 31, further comprising a fan for drawing in a steam and/or smoke generated below the microwave oven.

31. A method for controlling opening and/or closing of a door in a cooking apparatus comprising:
rotating a link member disposed between the door and a main body of a cooking chamber in response to either opening and/or closing of the door;
urging the link member in a first rotational direction when the a door is in a closed position; and
urging the link member in a second rotational direction during the opening of the door;

32. The method according to claim 31, further comprising the step of:
maintaining the position of the link member at a current state during the opening of the door when the position of the link member is rotated a predetermined angle from the state in which the door is closed.

33. A cooking apparatus comprising:
a main body having a cooking chamber;
a door link-coupled to the main body to open or close the cooking chamber;
at least one link member provided so as to be rotated when the door is opened or closed; and
a link control device to control operation of the link member, the link control device including a first pressing device, and
wherein when the door is closed, the first pressing device urges the link member in a first rotational direction.
